(19) United States
(12) Patent Application Publication
(10) Pub. No.: US 2021/0241019 A1
(43) Pub. Date: Aug. 5, 2021

(54) MACHINE LEARNING PHOTOGRAPHIC METADATA

(71) Applicant: salesforce.com, inc., San Francisco, CA (US)

(72) Inventors: Luke MacNeil, Douglas, MA (US); Paulson McIntyre, Sterling, VA (US)

(21) Appl. No.: 16/778,479

(22) Filed: Jan. 31, 2020

(51) Int. Cl. G06K 9/46; G06N 20/00; G06F 16/583; G06F 16/58

(52) U.S. Cl. CPC G06K 9/4604; G06F 16/5866; G06F 16/583; G06N 20/00

(57) ABSTRACT

A method and system for automated generation of photographic metadata in response to a machine learning algorithm including an input for receiving an image, a processor configured to perform an image recognition algorithm to generate a first metadata, to predict a second set of metadata in response to the first set of metadata and a set of rules generated in response to a machine learning training process wherein the set of rules are generated in response to a plurality of images having user generated metadata, and an output for transmitting the second set of metadata and the image to a storage medium.

### TECHNICAL FIELD

Embodiments of the subject matter described herein relate generally to automated image metadata generation. More particularly, embodiments of the subject matter relate to automatic photo tagging in response to a machine learning operation trained with previously submitted photographic metadata.

### BACKGROUND

As more and more electronic devices are developed that are continuously with users such as cameras, the number of photographs taken and saved by a user have increased dramatically. In addition, professional photographers capture and store increasingly large numbers of photographs with the infinite availability of digital image storage space and without the cost restrictions of film. In addition, automated image gathering algorithms and devices may generate a huge number of images which may be stored indefinitely. Identifying the content of these images or manually generating metadata, such as image tags indicating image content, for these images is impractical for an average user. Tagging photo libraries may be cumbersome for many photographers who may have extensive libraries that may benefit from automation. Accordingly, it is desirable to provide an improved method and apparatus for automated generation of image metadata. Furthermore, other desirable features and characteristics will become apparent from the subsequent detailed description and the appended claims, taken in conjunction with the accompanying drawings and the foregoing technical field and background.

### SUMMARY

Disclosed herein are metadata provision, control, and conversion methods and systems and related control logic for provisioning data management servers for executing data management algorithms. By way of example, and not limitation, there is presented various embodiments of automatic photo tagging in response to a machine learning operation trained with previously submitted photographic metadata are disclosed herein.

In accordance with an aspect of the present disclosure, an apparatus including an input for receiving an image, a processor configured to perform an image recognition algorithm to generate a first metadata, to predict a second set of metadata in response to the first set of metadata and a set of rules generated in response to a machine learning training process wherein the set of rules are generated in response to a plurality of images having user generated metadata, and an output for transmitting the second set of metadata and the image to a storage medium.

In accordance with another aspect of the present disclosure the machine learning training process is performed using a plurality of user stored images and associated user generated metadata.

In accordance with another aspect of the present disclosure the first metadata is generated in response to a characteristic of the set of rules.

In accordance with another aspect of the present disclosure the apparatus is a photographic image server.

In accordance with another aspect of the present disclosure the input is a universal serial bus port.

In accordance with another aspect of the present disclosure the input is an electronic storage medium.

In accordance with another aspect of the present disclosure the image recognition algorithm is performed in response to a request from a photographic image management application.

In accordance with another aspect of the present disclosure the user generated metadata is indicative of a category of metadata and wherein the first metadata is generated in response to the category of metadata.

In accordance with another aspect of the present disclosure, a method including receiving an image, performing an image recognition algorithm in response to the image to generate a first metadata, performing a comparison of the first metadata to a set of rules to generate a second metadata, the set of rules being generated in response to a plurality of images, each of the plurality of images having one of a plurality of user generated metadata, and generating an image file in response to the image and the second metadata.

In accordance with another aspect of the present disclosure wherein the set of rules are generated in response to a machine learning training process performed using a plurality of user stored images and associated user generated metadata.

In accordance with another aspect of the present disclosure wherein the first metadata is generated in response to a category of image defined by the set of rules.

In accordance with another aspect of the present disclosure wherein the input is an photographic image server configured to perform a photographic image management application.

In accordance with another aspect of the present disclosure wherein the input is a universal serial bus port.

In accordance with another aspect of the present disclosure wherein the input is an electronic storage memory card.

In accordance with another aspect of the present disclosure wherein the image recognition algorithm is performed in response to a control signal generated by an image management application.

In accordance with another aspect of the present disclosure including transmitting the image file to a device configured to perform an image management application.

In accordance with another aspect of the present disclosure the user generated metadata is indicative of a category of metadata and wherein the first metadata is generated in response to the category of metadata

In accordance with another aspect of the present disclosure, a system for image management including a first storage medium configured to store a first image having a first set of metadata, an image recognition processor operative to generate a second set of metadata in response to an image recognition algorithm and the first image, a digital signal processor configured to generate a third set of metadata in response to the second set of metadata and an artificial intelligence rule set generated in response to a previous image and a previous user generated metadata, a data processor operative to generate an image file in response to the first image, the first set of metadata, and the third set of metadata, and a second storage medium operative to store the image file for access by an image management application.

In accordance with another aspect of the present disclosure the artificial intelligence rule set is generated in response to a plurality of images and a plurality of user generated metadata associated with each of the plurality of images.

In accordance with another aspect of the present disclosure the first set of metadata is generated by a camera.

The above advantage and other advantages and features of the present disclosure will be apparent from the following detailed description of the preferred embodiments when taken in connection with the accompanying drawings.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows an exemplary relationship diagram for automated generation of image metadata using machine learning techniques according to an exemplary embodiment of the present disclosure.

FIG. 2 is block diagram of an exemplary system for automated generation of image metadata using machine learning techniques according to an exemplary embodiment of the present disclosure.

FIG. 3 is a flowchart of a method for automated generation of image metadata using machine learning techniques according to an exemplary embodiment of the present disclosure.

FIG. 4 is block diagram of another exemplary system for automated generation of image metadata using machine learning techniques according to an exemplary embodiment of the present disclosure; and

FIG. 5 is a flowchart of another method for automated generation of image metadata using machine learning techniques according to an exemplary embodiment of the present disclosure.

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A method and system are disclosed for the automated generation of photographic metadata in response to a machine learning algorithm. Image metadata may be used for cataloging and contextualizing visual information. Many photographers use the metadata and associated features for finding, sorting, cataloging and editing images and image directories. The method and system are operative to use previously customer entered metadata and/or photographic tags. The presently disclosed method and apparatus are operative to employ a user's previously entered data, or the data of larger groups and communities, to generate a training dataset, which is used to then categorize and tag future photos. Automated photo tagging and can save photographers and digital content creators hundreds of hours in their workflow by learning their organizational preferences and automatically applying them to future content. Additionally, it supports the development of sophisticated machine learning datasets that can be used for other purposes.

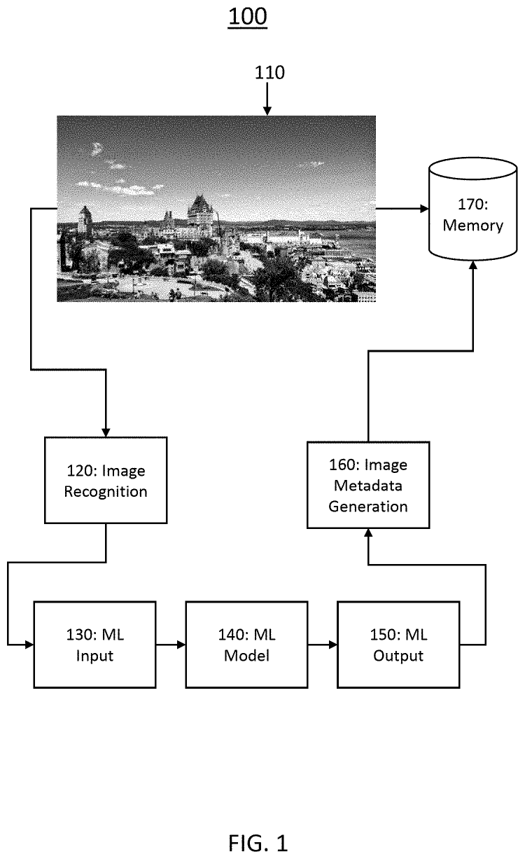

Turning now to FIG. 1, an exemplary relationship diagram 100 for automated generation of photographic metadata in response to a machine learning algorithm is shown. The exemplary relationship diagram 100 shows an image 110, an image recognition function 120, a machine learning input 130, a machine learning model 140, a machine learning output 150, an image metadata generation function 160, and a memory 170.

In this exemplary embodiment, the machine leaning model 140 is first trained using existing user images and existing user photo metadata, such a photo tags. The machine learning model 140 is operative to find relationships and develop an associated dataset between the machine learning input 130 generated in response to the existing images and the machine learning output 150 as compared to the existing user image metadata. The exemplary system is then operative to generate a machine learning output and an image metadata generation in response to newly received images. The newly received images may then be stored in the memory along with the newly generated image metadata.

In order to generate the machine learning input 130 for the machine learning model 140 in both the training mode and the operational mode, the system is first operative to perform an image recognition algorithm on the subject image. Data retrieved in response to the image recognition function 120 is then used as machine learning input 130 for the machine learning model 140. The machine learning output 150 is then generated in response to the machine learning model 140. In an exemplary embodiment, the machine learning output 150 corresponds to the organizational preferences and metadata preferences of the creator of the previously existing metadata used to train the machine learning model 140.

In an exemplary embodiment, the image 110 may be one of a plurality of images identified as requiring automatic metadata generation. The image 110 may be an electronic image file, such as a JPEG, TIFF, PNG, EPS and/or RAW file. The image may be stored in an input directory with one or more other images to have metadata generated or may be identified by a user input from a computer application or algorithm. The image 110 may include metadata generated in response to the image capturing processor of the image 110, by a camera that captured the image, such as geographical location, camera settings such as shutter speed, ISO number, focal depth, dots per inch, as well as file size, camera brand and model and date and time. This non subjective image metadata generated by the camera may be retained unalerted and be used as a portion of the final image metadata file stored in the memory 160 along with the image.

The image recognition 120 function may be operative to identify objects within the image, such as faces, objects, luminance, and other subject matter. The image recognition 120 function may further employ facial recognition algorithms to match detected faces in the image to previously detected and tagged faces from previous images. The previously detected faces may further be identified by user generated name tags which may then be used by the machine learning model 140 to generate name tags to be used for newly generated image metadata. In one exemplary embodiment, faces and associated tags from previous images are saved in a datafile and are used as references during future image metadata generation. In one exemplary embodiment, the image recognition may use rules generated in response to a machine learning model in order to generated the metadata according to user preferences defined by the rules.

The machine learning input 130 is operative to receive the output of the image recognition 120 algorithm and use this output as the input for the machine learning model 140. The machine learning model 140 is then operative to match the machine learning input 130 according to a number of relationships determined and weighted in response to the initial training images and metadata. The machine learning model 140 is then operative to generate a machine learning output 150 which correlates user preferred image tags and metadata with the image tags and metadata generated by the image recognition 120 function. The machine learning model 140 may employ neural networks or artificial intelligence processes and algorithms.

The image metadata generation 160 is operative to generate a metadata file to associated with the image 110 in response to the machine learning output 150. The image metadata generation 160 is operative to generate a metadata file in the appropriate format and may be indicative of a file storage destination, location and/or directory name or indicator in response to the user preferences or past behavior. The generated metadata and the image are then stored in the memory for later retrieval by the user or other image processing algorithm. The memory 170, and associated controller, may be operative to generate a new file directory or the like in response to the image metadata generation 160 data.

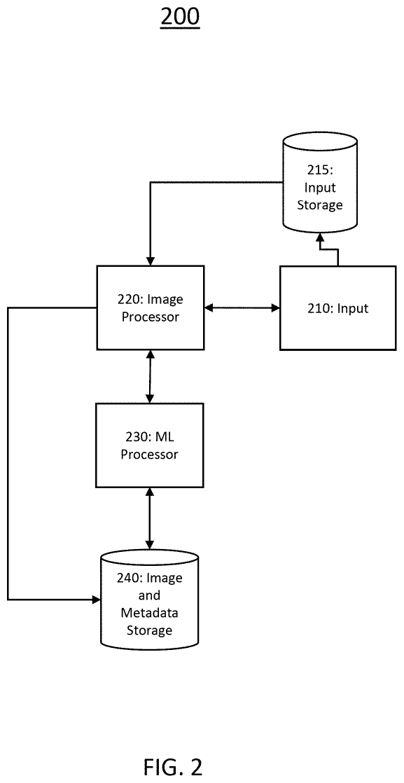

Turning now to FIG. 2, a block diagram of an exemplary system 200 for automated generation of photographic metadata in response to a machine learning algorithm is shown. The exemplary system includes an input 210, an input storage 215, an image processor 220, data processor 220, a machine learning processor 230 and an image and metadata storage 240. The input 210 is operative to receive one or more images. The input 210 may be a data port, such as a USB port, a memory card reader, a network interface, a wireless network interface or the like. The input 210 may be coupled by to a camera or the like. The input 210 may then be operative to couple the received image to an input storage 215 or to an image processor 220.

In an exemplary embodiment, the image processor 220 may be operative to receive an image from the input 210. In this exemplary embodiment, the image may be received via a computer data bus from the input 210 or may be retrieved from an input storage 215 operative to buffer and/or store images received at the input 210. The image processor 210 is then operative to perform image recognition algorithms in order to identify and detect objects or features in the image. Examples of the objects or features may include faces, people, landscape type such as mountains, clouds, water, snow, objects such as cars, shoes, hats, and other distinguishing objects. The image processor 220 is operative to generate a file indicative of the results of the image recognition algorithm and couple this file to the machine learning processor 230.

The machine learning processor 230 is operative to receive the results of the image processing algorithm from the image processor 220 and to perform a machine learning algorithm on the results. The machine learning algorithm may include artificial intelligence processes or neural network operations in performing the metadata generation algorithm. The machine learning processor 230 is then operative to estimate image tags and image metadata in response to the image processing results and the machine learning algorithm trained with previously submitted user data and images. The machine learning processor 230 is then operative to generate an image metadata file in response to the estimated image tags and metadata. The image metadata file is then coupled to the image and metadata storage 240 along with the image for later retrieval by a user or other image management application.

In one exemplary embodiment, the image processor 220 is operative to couple the image to the image and metadata storage 240 following the image recognition operation. In an alternative embodiment, the image processor 220 is operative to couple the image and the results of the image recognition operation to the machine learning processor 230. The machine learning processor 230 may then be operative to generate the image metadata and couple the image and the image metadata to the image and metadata storage 240.

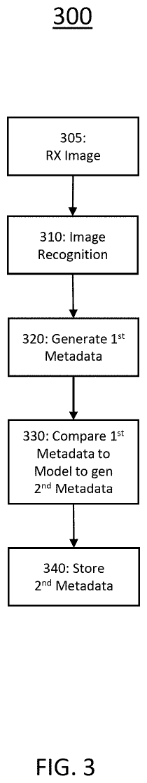

Turning now to FIG. 3, a flowchart 300 is shown of a method for automated generation of photographic metadata in response to a machine learning algorithm. The method is first operative to receive 305 an image. The image may be received via a data port such as a universal serial bus (USB) port coupled to a data storage device, a digital camera or the like. The image may further be received from a memory, such as a server or hard drive. The image may be received in response to a request from an image processor. The image may be in an image format such as RAW, JPEG, TIFF etc.

The method is next operative to perform 310 an image recognition process on the image to generate a first set to image metadata in response to the image recognition process and the image. The image recognition process may be operative to identify photographic conditions, such as luminance, color, intensity, contrast, etc., and/or may be operative to identify objects within the images, such as shoes, baseballs, food, etc. The image recognition process may be operative to identify activities within the images, such as skiing, ice hockey, baseball, football, dancing, etc.

In one exemplary embodiment, the image recognition process may be operative to use data from the machine learning process to identify categories of subject matter for the image recognition process. For example, if a user typically tags photos according to an activity being performed in the image, such as soccer or baseball, the image recognition process may focus on activities instead of objects within the images, such as grass, shoes, balls, etc. This results in the desirable affect of having the resulting photographic metadata more closely aligned with the users previously generated image metadata.

The method is next operative to generate 320 a second set of image metadata in response to a relationship model trained in response to a machine learning operation performed on previously stored images and user generated image metadata. This model may then be operative to transform 330 the first set of image data generated in response to the image recognition algorithm to a second set of image metadata more closely matching the estimated preferences of the user. The model may be generated in response to a machine learning algorithm tuned in response to image processing results and user entered metadata for images previously stored by a user.

The method is next operative to store 330 the second set of metadata in a memory. The second set of metadata may be stored along with the image file or may be integrated into a single file with the image file. The second set of metadata may be used to determine a storage location within the memory and may be used as part of a searching or classification scheme.

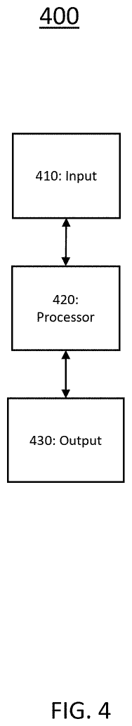

Turning now to FIG. 4, a block diagram illustrating a system 400 for automated generation of photographic metadata in response to a machine learning algorithm according to an exemplary embodiment of the present disclosure is shown. The exemplary system 400 may be a photographic image server performing a photographic image management application and may include an input 410, a processor 420 and an output 430.

In an exemplary embodiment of the system 400, the input 410 is operative for receiving an image. For example, the input 410 may be a universal serial bus port or an electronic storage memory card slot or the like, used for connecting to and powering, a portable electronic storage device and for transferring files, such as image files, to and from the portable electronic storage device. Alternatively, the input 410 may be an electronic storage medium such as a computer hard drive, cloud server, or other network or local electronic file server.

The processor 420 may be configured to perform an image recognition algorithm to generate a first metadata, to predict a second set of metadata in response to the first set of metadata and a set of rules generated in response to a machine learning training process wherein the set of rules are generated in response to a plurality of images having user generated metadata. In this exemplary embodiment, the machine learning training process is performed using a plurality of user stored images and associated user generated metadata and the first metadata is generated in response to a characteristic of the set of rules. For example, the user generated metadata is indicative of a category of metadata and wherein the first metadata is generated in response to the category of metadata. In an exemplary application, the image recognition algorithm may be performed in response to a request from a photographic image management application.

In this exemplary embodiment, the output 430 may be operative for transmitting the second set of metadata and the image to a storage medium. For example, the storage medium may include a file server as part of a photographic image management system and/or application.

In an additional exemplary embodiment, the system 500 may be a system for image management including an input 410 which may include a first storage medium configured to store a first image having a first set of metadata. In this example, the first image and the first set of metadata may be generated by a camera. The first set of metadata may include global positioning system location, file name and/or camera settings. The exemplary system 500 may include a processor 420 or processing block which may further include an image recognition processor operative to generate a second set of metadata in response to an image recognition algorithm and the first image, a digital signal processor configured to generate a third set of metadata in response to the second set of metadata and an artificial intelligence rule set generated in response to a previous image and a previous user generated metadata, and a data processor operative to generate an image file in response to the first image, the first set of metadata, and the third set of metadata. The exemplary system may further include an output 430 including a second storage medium, such as a cloud server, file server or the like, operative to store the image file for access by an image management application. An aspect of this exemplary embodiment may include the artificial intelligence rule set being generated in response to a plurality of images and a plurality of user generated metadata associated with each of the plurality of images.

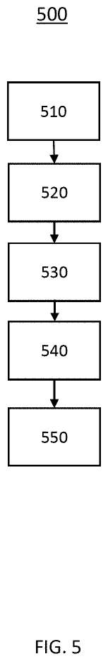

Turning now to FIG. 5, a flowchart illustrating a method 500 for automated generation of photographic metadata in response to a machine learning algorithm according to an exemplary embodiment of the present disclosure is shown. The method 500 is first operative for receiving 510 an image the input is a photographic image server configured to perform a photographic image management application. is a universal serial bus port electronic storage memory card

The method is next operative for performing 520 an image recognition algorithm in response to the image to generate a first metadata. In one exemplary embedment, the image recognition algorithm may be performed in response to a control signal generated by an image management application. The image recognition algorithm may be performed in response to a metadata associated with the image or a metadata generated in response to a user input, such as a preference to identify objects, activities, landscapes, people or other identifiable preferences. In another exemplary embodiment, the image recognition algorithm may be performed in response to a rule set generated by a machine learning algorithm in response to previous user generated metadata indicative of a user preference. For example, the user generated metadata may be indicative of a category of metadata and wherein the first metadata is generated in response to the category of metadata.

The method is next operative for performing a comparison 530 of the first metadata to a set of rules to generate a second metadata, the set of rules being generated in response to a plurality of images, each of the plurality of images having one of a plurality of user generated metadata. In an exemplary embodiment, the set of rules are generated in response to a machine learning training process performed using a plurality of user stored images and associated user generated metadata. the first metadata is generated in response to a category of image defined by the set of rules.

The method may next be operative for generating 540 an image file in response to the image and the second metadata and for transmitting 550 the image file to a device configured to perform an image management application.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The various tasks performed in connection with process may be performed by software, hardware, firmware, or any combination thereof. For illustrative purposes, the following description of process may refer to elements mentioned above. In practice, portions of process may be performed by different elements of the described system, e.g., component A, component B, or component C. It should be appreciated that process may include any number of additional or alternative tasks, the tasks shown need not be performed in the illustrated order, and process may be incorporated into a more comprehensive procedure or process having additional functionality not described in detail herein. Moreover, one or more of the tasks shown could be omitted from an embodiment of the process as long as the intended overall functionality remains intact.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. An apparatus comprising:
an input for receiving an image;
a processor configured to perform an image recognition algorithm to generate a first metadata, to predict a second set of metadata in response to the first set of metadata and a set of rules generated in response to a machine learning training process wherein the set of rules are generated in response to a plurality of images having user generated metadata; and
an output for transmitting the second set of metadata and the image to a storage medium.

2. The apparatus of claim 1 wherein the machine learning training process is performed using a plurality of user stored images and associated user generated metadata.

3. The apparatus of claim 1 wherein the first metadata is generated in response to a characteristic of the set of rules.

4. The apparatus of claim 1 wherein the apparatus is a photographic image server.

5. The apparatus of claim 1 wherein the input is a universal serial bus port.

6. The apparatus of claim 1 wherein the input is an electronic storage medium.

7. The apparatus of claim 1 wherein the image recognition algorithm is performed in response to a request from a photographic image management application.

8. The apparatus of claim 1 wherein the user generated metadata is indicative of a category of metadata and wherein the first metadata is generated in response to the category of metadata.

9. A method comprising:
receiving an image;
performing an image recognition algorithm in response to the image to generate a first metadata;
performing a comparison of the first metadata to a set of rules to generate a second metadata, the set of rules being generated in response to a plurality of images, each of the plurality of images having one of a plurality of user generated metadata; and
generating an image file in response to the image and the second metadata.

10. The method of claim 9 wherein the set of rules are generated in response to a machine learning training process performed using a plurality of user stored images and associated user generated metadata.

11. The method of claim 9 wherein the first metadata is generated in response to a category of image defined by the set of rules.

12. The method of claim 9 wherein the input is an photographic image server configured to perform a photographic image management application.

13. The method of claim 9 wherein the input is a universal serial bus port.

14. The method of claim 9 wherein the input is an electronic storage memory card.

15. The method of claim 9 wherein the image recognition algorithm is performed in response to a control signal generated by an image management application.

16. The method of claim 9 further comprising transmitting the image file to a device configured to perform an image management application.

17. The method of claim 9 where the user generated metadata is indicative of a category of metadata and wherein the first metadata is generated in response to the category of metadata

18. A system for image management comprising:
a first storage medium configured to store a first image having a first set of metadata;
an image recognition processor operative to generate a second set of metadata in response to an image recognition algorithm and the first image;
a digital signal processor configured to generate a third set of metadata in response to the second set of metadata and an artificial intelligence rule set generated in response to a previous image and a previous user generated metadata;
a data processor operative to generate an image file in response to the first image, the first set of metadata, and the third set of metadata; and
a second storage medium operative to store the image file for access by an image management application.

19. The method of claim 18 wherein the artificial intelligence rule set is generated in response to a plurality of images and a plurality of user generated metadata associated with each of the plurality of images.

20. The method of claim 18 wherein the first set of metadata is generated by a camera.
